(19) United States
(12) Patent Application Publication
(10) Pub. No.: US 2006/0064735 A1
(43) Pub. Date: Mar. 23, 2006

(54) Devices and methods for video signal integration

(75) Inventor: Ching Chuan Chen, Taipei (TW)

Correspondence Address: QUINTERO LAW OFFICE, 1617 BROADWAY, 3RD FLOOR, SANTA MONICA, CA, 90404, US

(73) Assignee: MITAC TECHNOLOGY CORP., HSIN-CHU HSIEN (TW)

(21) Appl. No.: 11/145,876

(22) Filed: Jun. 6, 2005

(30) Foreign Application Priority Data
Sep. 22, 2004 (TW) TW93128678

(51) Int. Cl. H04N 7/16

(52) U.S. Cl. 725/152

(57) ABSTRACT

A method for integrating video signals. A storage device is provided to a display device, comprising at least two sets of video specification information corresponding to the display device. The video signals are retrieved from a video source. Bit codes corresponding to one set of video specification information are generated according to the video signals. Clock synchronization signals corresponding to the video specification information are generated according to the video signals and the bit codes are transmitted according to the clock synchronization signals. The bit codes are translated to retrieve control commands therein. Video information corresponding to the video signals is accessed from the storage device according to the control commands and video specification information.

### BACKGROUND

The invention relates to video display devices, and more particularly, to devices and methods for integrating digital and analog video signals.

Conventionally, display devices can only receive and display analog video signals due to video technology limitations. Current display devices comply with Extended Display Identification (EDID) standards based on united video specifications and user convenience. The EDID standards define analog video display specifications and are stored in a flash memory complied with Display Data Channel (DDC) standards.

Referring to FIG. 1, monitor 1 may comprise a dual video interface, comprising a D-SUB connector 110 and a DVI connector 120. Corresponding video specification information corresponding to both the connectors is stored in DDC flash memories 115 and 125 respectively, and managed and controlled by a microcontroller 100 located in another DDC flash memory 105. Another DDC flash memory, however, is required, as monitor 1 comprises another video connector to store corresponding video specification information, increasing production cost. Additionally, when firmware updates are required, an update process is implemented simultaneously on at least three memory devices, respectively, of a monitor, such that firmware loss easily occurs.

Thus, an improved method for video signal integration is desirable.

### SUMMARY

Methods for video signal integration are provided. In an embodiment of such a method, a storage device is provided to the display device, comprising at least two sets of video specification information corresponding to the display device. The video signals are retrieved from a video source. Bit codes corresponding to one set of video specification information are generated according to the video signals. Clock synchronization signals corresponding to the video specification information are generated according to the video signals and the bit codes are transmitted according to the clock synchronization signals. The bit codes are translated to retrieve control commands therein. Video information corresponding to the video signals is accessed from the storage device according to the control commands and video specification information.

Also disclosed is a device for video signal integration. An embodiment of such a device comprises a storage medium and microcontroller. The storage medium stores EDID video information relating to a display device, defined by DDC standards. The microcontroller connects to SDC and SDA pins of a first video connector and a second video connector respectively through GPIO pins, retrieves the video signals from a video source, generates bit codes corresponding to one set of the video specification information according to one of the video signals, generates clock synchronization signals corresponding to the video specification information according to the video signals and transmits the bit codes according to the clock synchronization signals, translates the bit codes to retrieve control commands therefrom, and accesses video information corresponding to the video signals from the storage device according to the control commands and video specification information.

A detailed description is given in the following embodiments with reference to the accompanying drawings.

### BRIEF DESCRIPTION OF THE DRAWINGS

The invention can be more fully understood by reading the subsequent detailed description and examples of embodiments thereof with reference made to the accompanying drawings, wherein:

FIG. 1 is a schematic view of the architecture of a conventional video device;

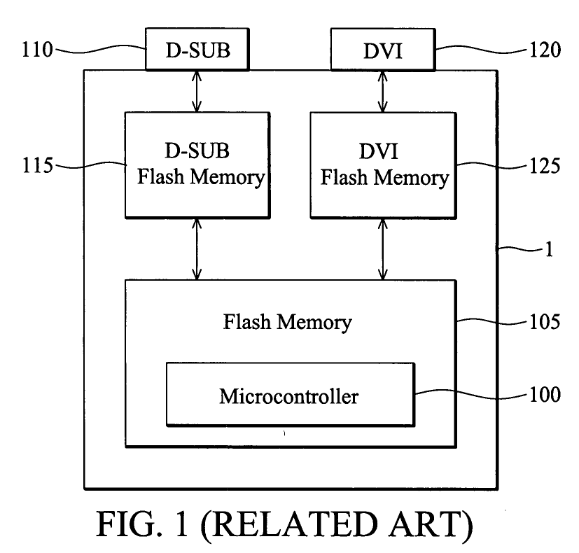

FIG. 2 is a schematic diagram of an embodiment of a device for video signal integration;

FIG. 3 is a timing chart of state change for inter-integrated circuit (I2C) transmission protocol;

FIG. 4 is a clock diagram of data transmission for I2C transmission protocol; and

FIG. 5 is a flowchart of an embodiment of a method for video signal integration.

### DETAILED DESCRIPTION

The invention discloses a device and method for video signal integration.

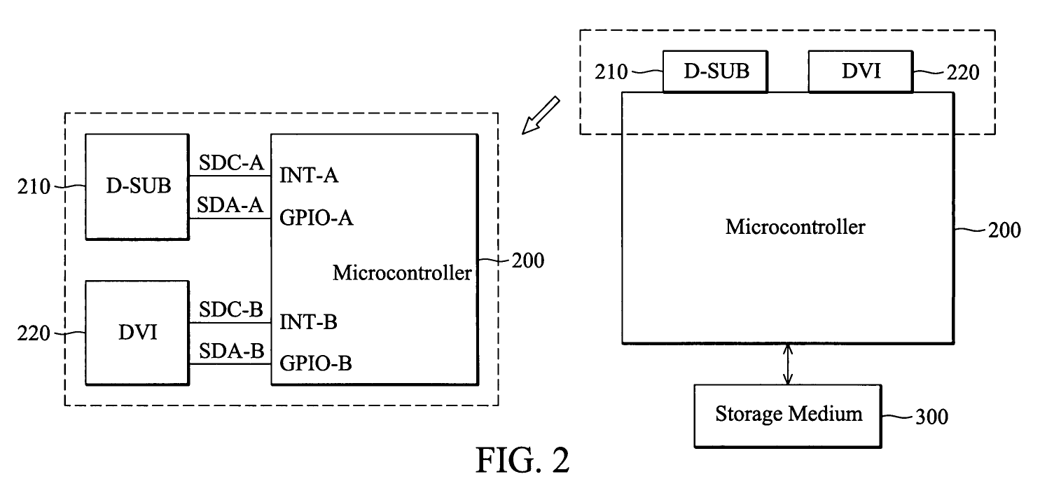

FIG. 2 is a schematic diagram of an embodiment of a device for video signal integration. The device of the invention comprises a microcontroller 200, coupled to an analog video connector 210 and a digital video connector 220, and a storage medium 300. Analog video connector 210 and digital video connector 220 comprise a Serial Data Clock (SDC) pin and a Serial Data Address (SDA) pin respectively, including SDC-A, SDC-B, SDA-A, and SDA-B. SDC-A, SDC-B, SDA-A, and SDA-B connect to General Purpose Input/Output (GPIO) pins (GPIO-A and GPIO-B) of microcontroller 200 respectively, in which pins connecting to SDC-A and SDC-B pins are defined as interrupt pins, including INT-A and INT-B.

Storage medium 300 stores EDID video information based on DDC standards relating to a monitor. A Display Data Channel (DDC) interfaces between a monitor and a computer system, defining video signals as SDC and SDA signals. SDA signals comprise information relating to monitor specifications and vendors stored in storage medium 300. SDC signals are synchronization clocks with respect to SDA signals, transmitted using an Inter-Integrated Circuit (I2C) communication mode of an integrated circuit component. An I2C communication mode is a serial communication mode, implementing serial communications between circuit components.

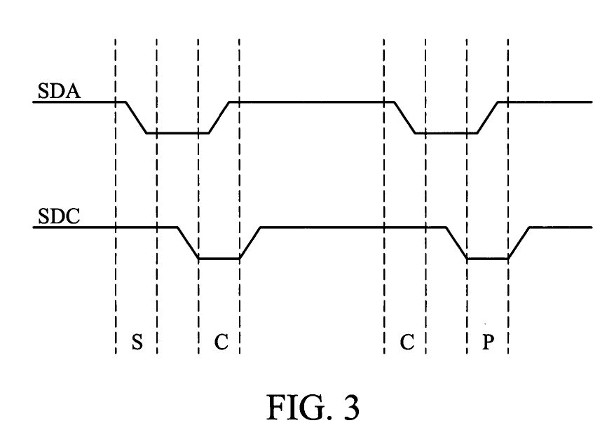

An I2C bus physically consists of 2 active wires and a ground connection. The active wires, called SDA and SDC, are both bi-directional. SDA is the Serial Data line, and SDC is the Serial Clock line. Both SDA and SDC are initially bi-directional, in a particular device, driven by the IC itself or from an external device. In order to achieve the described functionality, SDC and SDA signals use open collector or open drain outputs. Referring to FIG. 2, data communication with SDC and SDA signals begin with a start condition (shown in S area in FIG. 3) and terminate with a stop condition (shown in P area in FIG. 3), comprising transmitted addresses or data bits, read/write (R/W) bits, and acknowledged (ACK) bits.

A bus interface is built around an input buffer and an open drain or open collector transistor. When the bus is IDLE, the bus lines are in the logic HIGH state. To tag the bus, the chip drives its output transistor, thus pulling the bus to a LOW level. Clock on the SDC line is generated to transmit messages on the I2C-bus. Data is only valid during the HIGH period of the clock. A defined clock is therefore needed for the bit-by-bit arbitration procedure to take place.

Clock synchronization is performed using the wired-AND connection of I2C interfaces to the SDC line, a HIGH to LOW transition on the SDC line causing the devices concerned to start counting off their LOW period. Once a device clock has gone LOW, it holds the SDC line in that state until the clock HIGH state is reached. However, the LOW to HIGH transition of this clock may not change the state of the SDC line if another clock is still within its LOW period (shown in C area in FIG. 3). The SDC line therefore is held LOW by the device with the longest LOW period.

When all devices concerned have counted off their LOW period, the clock line is released and goes HIGH, resulting in no difference between the device clocks and the state of the SDC line, whereby all the devices start counting their HIGH periods. The first device to complete its HIGH period will again pull the SDC line LOW. In this way, a synchronized SDC clock is generated with its LOW period determined by the device with the longest clock LOW period, and its HIGH period determined by the one with the shortest clock HIGH period.

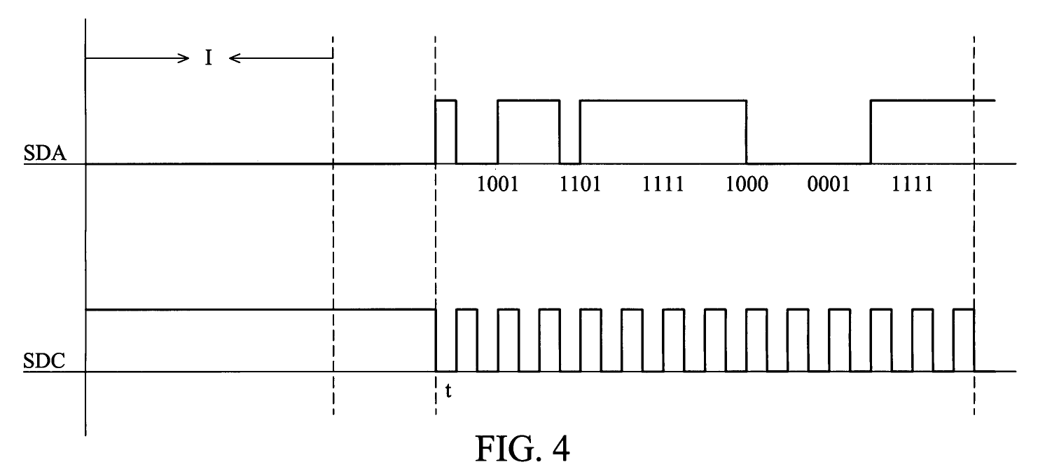

In this embodiment, as shown in area I in Fig.4, when a SDC pin is IDLE, it is provided with 3.3V or 5V by an external pull-high resistance, thus determining an event has been triggered in LOW state for an interrupt pin thereof. Data is retrieved using an SDA pin according to state changes of the SDC pin. The data is translated and video information stored in storage medium 200 retrieved accordingly. As shown in FIG. 4, for example, an event for an SDC pin is triggered in LOW state at time t and a host retrieves bit codes from an SDA pin according to each clock from the SDC pin. The bit codes are translated, thereby obtaining video information comprising signal types, resolution, and other specifications of a monitor. The video information is then returned using a GPIO pin.

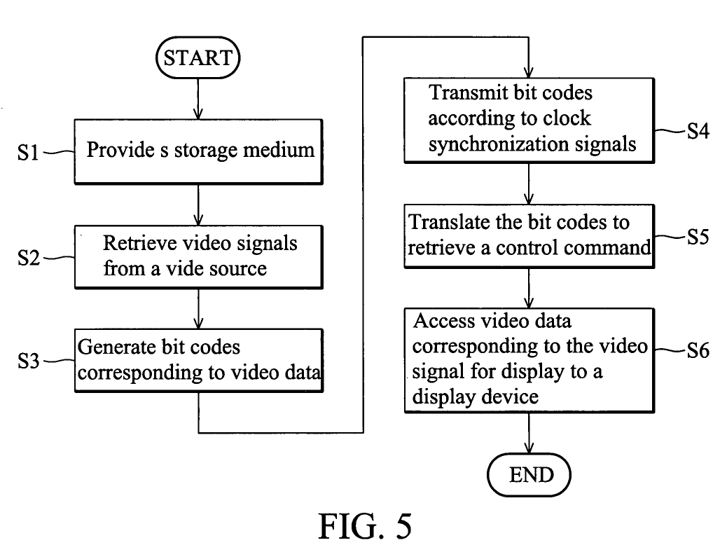

FIG. 5 is a flowchart of an embodiment of a method for video signal integration.

In step S1, a storage medium, a microcontroller, an analog video connector, and a digital video connector are provided. The microcontroller couples to the analog and digital video connector respectively. The analog and digital video connectors comprise an SDC pin and an SDA pin respectively, connecting to GPIO pins of the microcontroller respectively. GPIO pins connecting to SDC pins are defined as interrupt pins. The storage medium stores EDID video information based on DDC standards relating to a monitor.

In step S2, video signals are retrieved from a video source.

In step S3, corresponding bit codes are generated according to the video signals retrieved from a SDA pin.

In step S4, corresponding clock synchronization signals are generated according to the video signals retrieved from a SDC pin corresponding to the SDA pin and the generated bit codes are transmitted according to the clock synchronization signals.

In step S5, the bit codes are translated to retrieve control commands therein.

In step S6, video information, such as specifications relating to a monitor, corresponding to the video signals is retrieved from the storage medium according to the control commands. The specifications of a monitor comprise resolution, scan frequency, and so forth. The video information is then returned to the monitor using GPIO pins for display.

The invention integrates different video specifications with different interfaces into a memory device of a monitor, reducing production cost and preventing firmware loss.

Although the present invention has been described in terms of preferred embodiment, it is not intended to limit the invention thereto. Those skilled in the technology can still make various alterations and modifications without departing from the scope and spirit of this invention. Therefore, the scope of the present invention shall be defined and protected by the following claims and their equivalents.

What is claimed is:

1. A method for video signal integration, receiving and displaying video signals on a display device, comprising:
providing a storage device to the display device, comprising at least two sets of video specification information corresponding to the display device;
retrieving the video signals from a video source;
generating bit codes corresponding to one set of video specification information according to the video signals;
generating clock synchronization signals corresponding to the video specification information according to the video signals and transmitting the bit codes according to the clock synchronization signals;
translating the bit codes to retrieve control commands therein; and
accessing video information corresponding to the video signals from the storage device according to the control commands and video specification information.

2. The method for video signal integration as claimed in claim 1, wherein the video specification information comprises digital and analog video specification information.

3. The method for video signal integration as claimed in claim 1, wherein the display device further comprises a microcontroller, coupled to a digital video connector and an analog video connector of the display device respectively.

4. The method for video signal integration as claimed in claim 1, wherein the video information is accessed from the storage medium using an I2C protocol.

5. A device for video signal integration, receiving and displaying video signals on a display device, comprising:
a storage medium, storing EDID video information relating to the. display device, defined by DDC standards; and
a microcontroller, coupled to the storage medium, connecting to a SDC pin and SDA pin of a first video connector and a second video connector respectively through GPIO pins, retrieving the video signals from a video source, generating bit codes corresponding to one set of video specification information according to the video signals, generating clock synchronization signals corresponding to the video specification information according to the video signals and transmitting the bit codes according to the clock synchronization signals, translating the bit codes to retrieve control commands therefrom, and accessing video information corresponding to the video signals from the storage device according to the control commands and video specification information.

6. The device for video signal integration as claimed in claim 5, wherein the video specification information comprises digital and analog video specification information.

7. The device for video signal integration as claimed in claim 5, wherein the video information is accessed from the storage medium using an I2C protocol.

8. The device for video signal integration as claimed in claim 5, wherein the first video connector is an analog video connector and the second video connector is a digital video connector.
